(19) United States
(12) Patent Application Publication
(10) Pub. No.: US 2008/0163751 A1
(43) Pub. Date: Jul. 10, 2008

(54) COATED PISTON AND COATING METHOD

(76) Inventors: Vijay Subramanian, Murfreesboro, TN (US); Nicholas LoBiondo, Macomb, MI (US); Bruce Inwood, Fenton, MI (US); Sukhvinder Singh, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/970,774

(22) Filed: Jan. 8, 2008

Related U.S. Application Data
(60) Provisional application No. 60/884,114, filed on Jan. 9, 2007.

(51) Int. Cl. F16J 1/01; F16J 1/08; B23P 15/10

(52) U.S. Cl. 92/223; 29/888.048

(57) ABSTRACT

A piston formed from an Al alloy, such as an Al—Si alloy, has wear resistant coating applied to a predetermined portion of the outer surface. The predetermined portion of the outer surface preferably includes the piston skirt. The coating includes an adhesion promoting primer layer of a silane and a polymer coating layer. The silane primer coating promotes adhesion between the Al-alloy and the polymer coating. A method for making a piston of the type described includes the steps of: fabricating a piston having an outer surface; cleaning the outer surface of the piston by applying a cleaning solution to the outer surface; rinsing the outer surface of the piston with a rinse to remove the cleaning solution from the outer surface of the piston; applying a primer coating comprising a silane to at least a predetermined portion of the outer surface of the piston; drying the primer coating onto the outer surface of the piston; and applying a polymer coating to a predetermined portion of the outer surface of the piston.

This application claims priority to U.S. Provisional Application Ser. No. 60/884,114, filed Jan. 9, 2007 and is incorporated herein by reference.

### BACKGROUND OF THE INVENTION

1. Technical Field

This invention is generally related to pistons and methods of their manufacture. More particularly, it is related to pistons having coatings to improve scuff and wear resistance, friction, and noise and metal surface treatment to improve the adhesion of the coating(s) and methods of their manufacture.

2. Related Art

Al alloys, particularly Al—Si alloys are commonly used in the manufacture of pistons for application in internal combustion engines for automotive and other applications. While Al—Si alloy pistons have generally acceptable performance in a wide variety of internal combustion engine applications, there remains a need to improve the performance of pistons manufactured from these alloys with respect to critical sliding contact regions of these pistons.

One such sliding contact region during engine operation relates to the portion of the piston surface which functions as the interface between the piston and the cylinder sidewall, particularly the piston skirt. In internal combustion engines which use reciprocating pistons, the pistons incorporate a piston skirt. The piston skirt generally comprises the lowermost sidewall of the piston and is generally located beneath and extends downwardly from the lowermost ring groove.

The piston skirt is a portion of the piston during engine operation, and frequently incorporates a coating which is intended to improve its friction and wear properties during operation, such one of a number of different engineering thermoset and thermoplastic polymer coatings. These polymer coatings are generally applied as one of the final steps in the manufacture of Al alloy pistons. They are generally applied after the final machining of the piston surface, including the piston skirt, and ring grooves to obtain the desired profile and surface finish. However, such polymer coatings may not have sufficient adhesion strength when bonded directly to the finished surface Al alloy pistons. Therefore, pretreatment of the surface to be coated with an adhesion promoting process is frequently employed. One such pretreatment method and coating involves phosphate conversion of the surface of the piston. Phosphating is typically carried out with commercially available chemical processes. While generally effective at improving the adhesion of polymer coatings over those applied to untreated Al alloy surfaces control of the process can be difficult and costly and the phosphated surface can be detrimental on some un-coated parts of the piston. In addition to the limitation of process control of phosphated surfaces, the phosphate treatment process requires significant treatment of waste water and other effluents associated with the process.

In view of ever increasing demands for performance improvement in internal combustion engines, it is desirable to develop improved primer or adhesion promoting coatings for use on Al alloy pistons to improve the reliability of polymer coatings on piston wear surfaces, such as piston skirts. It is also desirable to develop improved coating processes which require reduced post-process treatment of residual process materials

### SUMMARY OF THE INVENTION

One aspect of the invention is directed to an Al alloy piston, preferably an Al—Si alloy piston, having an improved coating on a predetermined portion of its outer surface. The predetermined portion of the outer surface is the piston skirt. The coating includes a primer coating of a silane and a polymer based coating, such as an epoxy or polyamide-imide/graphite/molybdenum disulphide coating. The silane of the primer coating and the polymer coating are selected so as to promote strong chemical bonding, including polymerization reactions, between them.

Pistons having such coatings represent an improvement over related art pistons and piston manufacturing methods, such as those which utilize phosphate primers, by utilization of a method which includes: fabricating a piston having an outer surface; applying a primer coating comprising a silane to at least a predetermined portion of the outer surface of the piston; drying the primer coating onto the outer surface of the piston; and applying a polymer coating to a predetermined portion of the outer surface of the piston.

According to another aspect, a method is provided for making a piston assembly, including preparing a piston, a connecting rod and a wrist pin. The piston is joined to the connecting rod by the wrist pin to establish an articulated piston joint with multiple contact surfaces. At least one of the contact surfaces is coated with a coating containing silane to reduce friction. The contact surfaces are preferably free of sliding bearings and/or bushings, with the silane material serving as a bearing layer material at the at least one contact surface.

### BRIEF DESCRIPTION OF THE DRAWINGS

These and other features and advantages of the present invention will become more readily appreciated when considered in connection with the following detailed description and appended drawings, wherein like figures have like designations, and wherein:

FIG. 1 is a view of a piston of the invention looking in the direction of the pin bore axis;

FIG. 2 is a side view of the piston of FIG. 1;

FIG. 3 is a cross-section view taken along line 3-3 of FIG. 2; and

FIG. 4 is a flow chart of the steps of the method of the invention.

### DETAILED DESCRIPTION OF THE PREFERRED EMBODIMENT

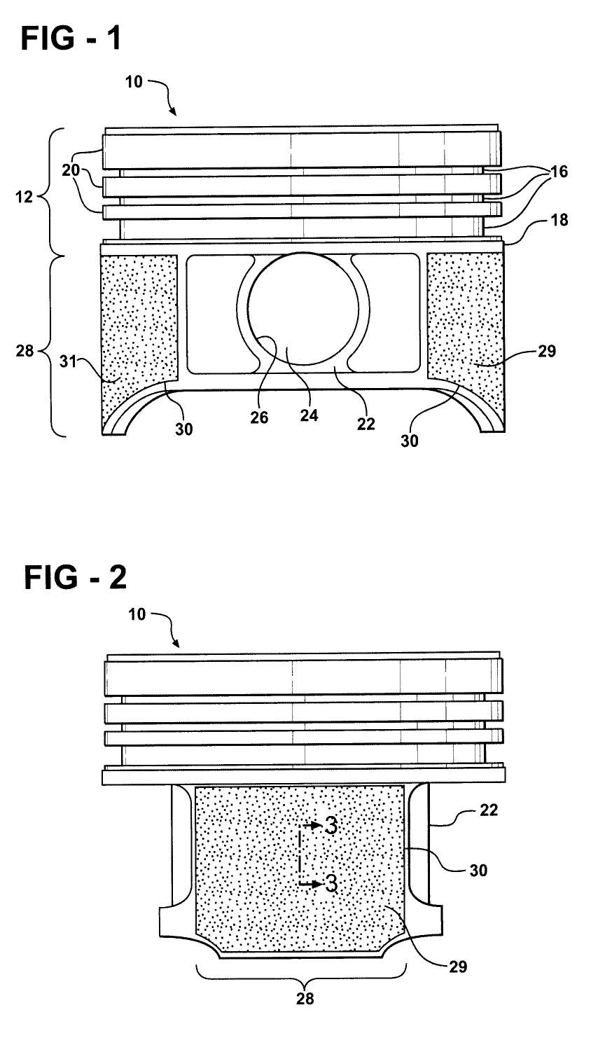

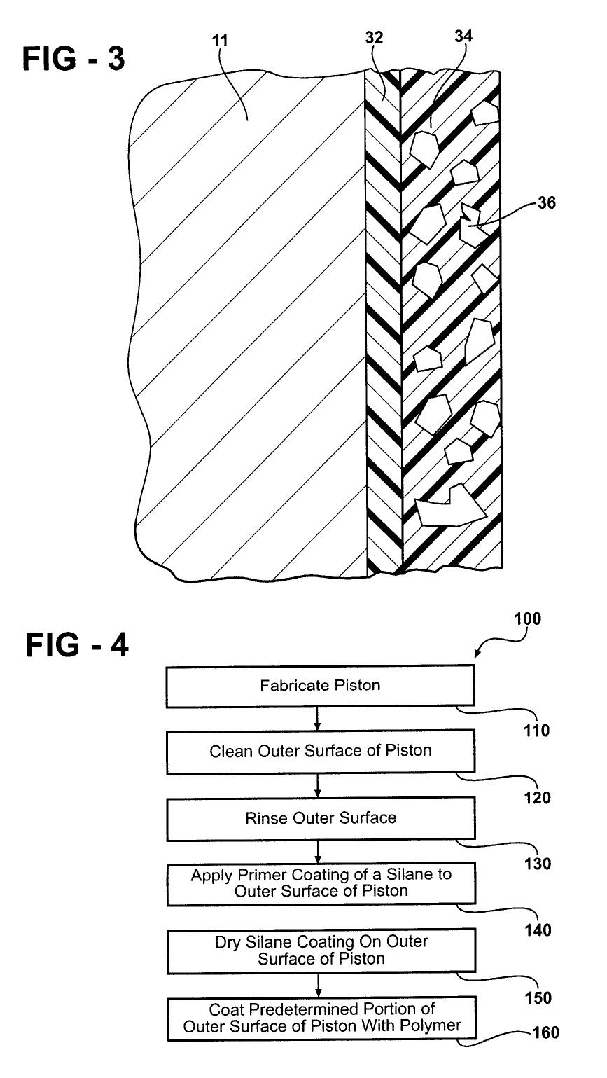

Referring to FIGS. 1-3, a piston 10 is shown for use in a reciprocating piston internal combustion engine of an automotive vehicle. Piston 10 is formed from an Al alloy 11. Preferably, a piston 10 formed from an Al—Si alloy. The Al—Si alloy may be any Al—Si alloy having a predetermined average concentration of both aluminum and silicon which is determined by the application requirements. It is preferred that piston 10 be formed from eutectic or hyper-eutectic Al—Si alloys. Alloys of the present invention may also include small amounts of any of a number of other alloying constituents, including small amounts of Cu, Mg, or Ni, or combinations of them, in order to affect the physical metallurgy and mechanical properties of piston 10. Such Al—Si alloys are generally known. Referring to FIG. 1, piston 10 is generally cylindrical, although other piston shapes may also be utilized. In the embodiment illustrated in FIG. 1, piston 10 has a piston crown 12 and a piston skirt 14. In crown 12 there formed a plurality of circumferential or annular grooves 16 which extend radially and inwardly from outer surface 18 of piston 10. Crown 12 also includes a plurality of lands 20 in the outer surface 18 associated with annular grooves 16. Piston 12 also includes two opposing piston pin bosses 22 (only one of which is shown) which extend downwardly from crown 12 and which each also include a pin boss bore 24 which is adapted to receive a conventional piston pin (not shown) in order to connect piston 10 to a conventional connecting rod (not shown). The connection establishes an articulated piston pin joint in which multiple contact surfaces of the assembled joint components act on one another during dynamic operation of the piston assembly. Each pin boss bore 22 has an annular bore surface 26. Piston 10 also includes a piston skirt 28 formed in outer surface 18. Piston skirt 28 generally comprises the annular sidewall portion of piston 10 located below the lowermost ring groove and comprises a principal bearing surface of the piston against the cylinder sidewall during operation of piston 10 in an internal combustion engine. Piston skirt 28 has a major thrust face 29 being that portion of the piston skirt which carries the greatest thrust load (corresponding to the principal or favored direction of rotation of the engine) which is frequently on the right side when viewing the engine from the flywheel end with the crankshaft rotating counterclockwise and a minor thrust face 31 being that portion of the piston skirt which is opposite the major thrust face. During operation of internal combustion engine, a predetermined portion 30 of outer surface 18 comprising piston skirt 28 is subjected to high friction, high wear due to friction associated with bearing contact between the portions of outer surface 18 in these regions and other components of the engine or other device incorporating piston 10, such as cylinder sidewall. Referring to FIG. 3 the predetermined portion 30 comprising the high friction, high wear surface may include the entirety of outer surface 18 associated with piston skirt 28, or may comprise only a lesser predetermined portion 30 of outer surface 18 associated with piston skirt 28. Predetermined portion 30 may include any pattern or shape, including regular or irregular patterns, as illustrated in FIGS. 1-3. FIGS. 1-3 illustrate one embodiment of a piston of the present invention, however, many other piston designs are known, including various piston skirt shapes and configurations, various pin boss/bore configurations, and shapes and sizes of predetermined portion 30 which may also be utilized with an Al alloy piston in accordance with the present invention.

Referring again to FIGS. 1-3, piston 10 has a primer or adhesion promoting coating layer 32 comprising a silane attached to outer surface 18. Primer coating 32 will be attached to at least predetermined portion 30 of outer surface 18. Preferably, primer coating layer 32 is attached to substantially all of outer surface 18 in order to simplify the coating process by which primer coating layer 32 is applied and attached to outer surface 18, as described further below. A polymer coating 34 is attached to predetermined portion 30 of outer surface 18 comprising piston skirt 28 over primer coating 32. The polymer coating 34 is attached to predetermined portion 30 which includes major thrust face 29 and minor thrust face 31.

A silane is the principal constituent of primer coating 32. A “silane” is any silicon analog of an alkane hydrocarbon. Silanes consist generally of a chain of silicon atoms covalently bound to hydrogen atoms. The general formula of a silane is SiₙH₂ₙ₊₂. This use includes cyclosilanes, or silanes in a ring configuration, analogous to cycloalkanes or alkanes in a ring configuration. It also includes various forms of branched silanes, again analogous to branched alkanes. As used herein, silane also refers generally to silanes in any of these forms having any number of associated organic or inorganic functional groups attached. The silane of primer coating 32 may be any silane that promotes or enhances the adhesion strength of polymer coating 34 to the Al alloy 19 which comprises outer surface 18 of piston 10. Preferably, a silane will be selected which contains functional groups which are adapted to provide a strong covalent or other chemical bond to one or more constituents of polymer coating 34. Therefore, the silane of primer coating 32 and polymer coating 34 will be selected to optimize the bond strength between them, such as by selecting them to promote cross-linking between the functional groups of the silane and the constituents of polymer coating 34. For example, if polymer coating 34 comprises an epoxy-based polymer, preferred silanes include gamma-aminopropyltrialkoxysilane, vinyltrialkoxysilane and various other epoxy silanes, such as those which include; in the uncured form, one or more reactive epoxide or oxirane groups Primer coating 32 will preferably be selected from a group consisting of: Primer coating 32 is preferably applied in a very thin layer, generally having a thickness of 1 μm or less, which is dried onto the predetermined portion of 30 of outer surface 18.

Polymer coating 34 may be any polymer coating which will provide wear resistance to piston 10 in a given application environment. Polymer coating 34 will also preferably include a plurality of particles 36 of a solid lubricant dispersed in polymer coating 34 as a matrix. Polymer coatings may include, for example, epoxy-based, polyamideimide-based and phenolic-based coatings and the like. The plurality of particles 36 of solid lubricant may include, for example, particles of graphite, molybdenum disulphide, polytetrafluoroethylene, hexagonal boron nitride (HBN) and the like. Polymer coating 34 will preferably have a thickness in a range of between about 2-40 μm, and more preferably in the range of about 8-20 μm.

According to another aspect of the invention, and referring to FIG. 4, piston 10 may be made by a method 100 comprising the steps of: fabricating 110 a piston 10 having an outer surface 18; cleaning 120 the outer surface 18 of the piston 10 by applying a cleaning solution to the outer surface 18 of the piston 10; rinsing 130 the outer surface of the piston with a rinse following the step of cleaning to remove the cleaning solution from the outer surface of the piston; applying 140 a primer coating comprising a silane to at least a predetermined portion of the outer surface of the piston; drying 150 the primer coating comprising the silane on the outer surface of the piston; and applying 160 a polymer coating to a predetermined portion of the outer surface of the piston. Method 100 and steps 110-160 are described in further detail below.

The step of fabricating 110 a piston 10 having an outer surface 18 may be performed using conventional materials and processes. Piston will preferably be formed from an Al-alloy 19, and more preferably from an Al—Si alloy. Piston 10 may be fabricated by casting the general form of the piston followed by machining and the like of the features described above and shown in FIGS. 1 and 2 into outer surface 18, or alternately, piston 10 may be fabricated from an extruded billet, such as a cylindrical billet, by machining and the like of the features described above and shown in FIGS. 1 and 2 into outer surface 18. Machined pistons 10 will preferably be cleaned prior to application of primer coating or polymer coating to remove oils and other residual materials associated with machining or other aspects of their fabrication.

Following the step of fabricating 100 piston 10, method 100 optionally, but preferably, includes a step of cleaning 120 the outer surface 18 of the piston 10. Cleaning 110 may be performed using any of a number of known cleaning techniques to remove oils and other residual materials from outer surface 18. This may include dry processes, such as plasma etching or the like, or various wet processes, such as applying liquid cleaning solutions to outer surface 18. Generally, wet processes utilizing alkaline cleaning solutions, such as those comprising KOH or NaOH are preferred. Cleaning solution concentrations, times and temperatures for use with Al alloys, including Al—Si alloys, are well-known.

When alkaline cleaning solutions are employed, method 100 also optionally, but preferably, includes a step of rinsing 130 the cleaning solution from the outer surface 18 of piston 10. When alkaline cleaning solutions, such as KOH or NaOH are utilized, rinsing 130 preferably employ the use of a rinse comprising purified water, such as water purified by deionization or by reverse osmosis filtration or the like. Rinsing times and temperatures for removing residual cleaning solutions of the types described herein are also well-known.

Method 100 also includes a step of applying 140 a primer coating 32 comprising a silane to at least a predetermined portion 30 of the outer surface 18 of the piston. Silanes are generally in the form of a liquid at room temperature and may be applied by any of a number of known methods for applying a liquid to a surface having the geometry of outer surface 18, including dipping piston 10 in a solution comprising the silane, spraying a solution comprising the silane onto outer surface 18, or other methods of application including screen printing, painting, pad printing or the like. When dipping is employed, it is preferable to immerse piston 10 in the silane solution, thereby providing primer coating over all of outer surface 18; however, partial immersion of the predetermined portion 30 of outer surface 18 also may be employed. When spraying, pad printing, painting or other application techniques are employed, primer coating may be applied to all of outer surface 18, or it may be limited just to predetermined portion 30, or variations between these bounds. Applying 140 of primer coating 32 by any of the techniques generally described herein may be performed using any of a number of well-known equipment and application methods. For many types of silanes and application methods, such as spraying or dipping, it is possible to collect and reuse the excess material, such as sprayed material which either does not strike, or strikes but does not remain on (i.e., drips off) the outer surface 18, or such as dipped material which runs off from outer surface 18. As such, this is principally an additive process which enables recycling of excess materials. This represents a significant improvement and simplification over methods used to apply related art primer coatings, such as phosphate coatings, where processes are often complex and the reactants used to prime the piston surface have limited recyclability, and where the reaction byproducts frequently require extensive and costly waste treatment.

Following the step of applying 140 primer coating 32, method 100 optionally, but preferably, includes a step of drying 150 the primer coating onto the portion of outer surface to which it has been applied, particularly if the solution comprising silane incorporates any volatile constituents. Drying 150 may include room temperature drying, or drying at an elevated temperature.

While it is possible to provide pistons 10 having only primer coating 32 applied as a product, whereupon, polymer coating 34 may be applied subsequently or not, it is preferred that method 100 also include a step of applying 160 polymer coating 34 of the types described herein to predetermined portion 30 of outer surface 18. The method of application will preferably be selected based upon the nature and properties of the polymer coating 34 to be applied. For application of polymer coatings 34, or unpolymerized or partially polymerized precursors to polymer coatings, as a liquid, the methods described above with regard to primer coating 32 are also applicable. For application of polymer coating 34 as a solid, other well-known application techniques may be employed. For example, if polymer coating 34 comprises an epoxy, the uncured epoxy precursor materials may be applied as a liquid, such as by pad printing, screen printing or painting.

Following the step of applying 160 polymer coating 34 to predetermined portion 30, it may be desirable to cure unpolymerized or partially polymerized constituents using any of a number of well-known polymerization techniques, including application of heat, light or polymerization initiators.

According to another aspect of the invention, the above described silane materials may be applied to one or more of the contact surfaces of the piston joint to decrease friction and wear. As such, the silane-containing material may be applied to the pin bore contact surfaces of the piston, or the contact surface(s) of the wrist pin, or the pin bore of the connecting rod, or combinations thereof. In such case, the piston, connecting rod and wrist pin may be made of various materials not limited to those discussed above.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A piston, comprising:
a piston formed from an Al alloy and having an outer surface; and,
a primer coating comprising a silane which is attached to the outer surface of the piston.

2. The piston of claim 1, wherein the Al alloy comprises an Al—Si alloy.

3. The piston of claim 1, wherein said primer coating has a thickness of 1 μm or less.

4. The piston of claim 1, further comprising:
a polymer coating attached to a predetermined portion of the outer surface of said piston and said primer coating.

5. The piston of claim 4, wherein said polymer coating is selected from a group consisting of: an epoxy polymer, a polyamideimide polymer and a phenolic polymer.

6. The piston of claim 5, wherein said polymer coating also has a plurality of particles of a solid lubricant dispersed therein.

7. The piston of claim 6, wherein the solid lubricant is selected from a group consisting of: graphite, polytetrafluoroethylene, hexagonal boron nitride and molybdenum disulfide.

8. The piston of claim 7, wherein the polymer coating has a thickness in the range of about 2-40 μm.

9. The piston of claim 6, wherein the predetermined portion of the outer surface comprises a piston skirt.

10. A method of making a piston, comprising the step of:
fabricating a piston having an outer surface;
cleaning the outer surface of the piston by applying a cleaning solution to the outer surface of the piston;
rinsing the outer surface of the piston with a rinse following the step of cleaning to remove the cleaning solution from the outer surface of the piston;
applying a primer coating comprising a silane to at least a predetermined portion of the outer surface of the piston;
drying the primer coating comprising the silane on the outer surface of the piston; and
applying a polymer coating to a predetermined portion of the outer surface of the piston.

11. The method of claim 10, wherein said step of cleaning comprises applying an alkaline cleaning solution to the outer surface of the piston.

12. The method of claim 11, wherein the alkaline solution comprises KOH or NaOH.

13. The method of claim 10, wherein the rinse comprises water.

14. The method of claim 10, wherein the predetermined portion of the outer surface of the piston comprises a piston skirt.

15. The method of claim 10, wherein the piston comprises an Al alloy.

16. The method of claim 16, wherein the Al alloy comprises an Al—Si alloy.

17. The method of claim 10, wherein the polymer coating is selected from a group consisting of: an epoxy polymer, a polyamideimide polymer and a phenolic polymer.

18. A method of making a piston assembly, comprising:
preparing a piston, a connecting rod and a wrist pin joinable to one another to establish an articulated piston joint having multiple contact surfaces;
applying a coating comprising silane to at least one of the contact surfaces; and
assembling the piston, connecting rod and wrist pin.

19. The method of claim 18, including applying the coating to more than one of the contact surfaces.
